(19) United States
(12) Patent Application Publication
(10) Pub. No.: US 2025/0120394 A1
(43) Pub. Date: Apr. 17, 2025

(54) SILANE SURFACTANT FOR AGRICULTURAL USE

(71) Applicant: MOMENTIVE PERFORMANCE MATERIALS INC., Niskayuna, NY (US)

(72) Inventors: George A. Policello, Ossining, NY (US); Benjamin Falk, Yorktown Heights, NY (US); Arindam Sannigrahi, Bangalore (IN); Linh The Truong, Congers, NY (US)

(21) Appl. No.: 18/916,860

(22) Filed: Oct. 16, 2024

Related U.S. Application Data
(60) Provisional application No. 63/544,290, filed on Oct. 16, 2023.

(51) Int. Cl. A01N 25/30; A01N 25/32; C07F 7/18

(52) U.S. Cl. CPC A01N 25/30; A01N 25/32; C07F 7/1892

(57) ABSTRACT

A silane composition is shown and described herein. The silane composition includes a dialkyleneoxide functional dialkoxyalkyl silane. The silane composition exhibits low toxicity and biodegradability. The silane composition is suitable for use as an adjuvant in a variety of applications including, for example, in treating agricultural areas.

### CROSS-REFERENCE TO RELATED APPLICATIONS

This application claims priority to and the benefit of U.S. Provisional Application No. 63/544,290 titled “Silane Surfactant for Agricultural Use,” filed on Oct. 16, 2023, the disclosure of which is incorporated herein by reference in its entirety.

### FIELD OF INVENTION

The present invention relates to a silane composition. In particular, the present invention relates to a silane-based composition suitable for use as a surfactant. Even more particularly, the present silane-based compositions are suitable for use as an adjuvant for improving the deposition and performance of agrochemicals.

### BACKGROUND

Many agrochemical formulations and spray mixtures benefit from the inclusion of surfactants. For example, including certain surfactants in an agrochemical spray tank-mixture can efficiently reduce the surface tension of the spray solution. This can improve the ability of the spray droplets to adhere to the surface to which it is applied, and to spread over a larger area of the plant surface. Conventional trisiloxane-based surfactants have been used in such applications and do show improved spreading and spray coverage. These surfactants, however, are not readily biodegradable and typically have a low LD50 for aquatic toxicology, which results in a GHS Class 2 Chronic Aquatic toxicology classification. As such, they may not be suitable in certain applications or with certain products depending on the end use of the product being treated.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

In one aspect, provided is a silane composition. The compositions are suitable for use as adjuvants in agrochemical applications. The compositions are suitable for the application of agrochemicals to a plant surface. The compositions provide spreading comparable to or better than conventional adjuvants. The present silane compositions, however, exhibit low toxicity and/or biodegradability.

In one aspect, the present silane composition enhances the spreading and improves the efficacy of agrochemical sprays, while providing a low toxicity profile adjuvant that is one or more of readily biodegradable, has a GHS Class 2 acute aquatic toxicity or a GHS 3 aquatic toxicity classification, and/or an acute oral toxicity profile where the Acute Oral LD50 is ≥2000 mg/Kg (Rat). These properties or characteristics are not all attainable using the conventional trisiloxane alkoxylate adjuvants. In another aspect, the silane composition falls under the category of “Not Classified” with respect to toxicity.

The present compositions may be employed with, for example, agrochemicals including, but not limited to, herbicides, insecticides, fungicides, biologicals, fertilizers, growth regulators, and the like.

In one embodiment, provided is a silane composition comprising a silane of the formula:

R¹OSi(R²)(Z)OR³ (I)

wherein: R¹ and R³ are each independently selected from a hydrocarbon group having 4 to 8 carbons, where a carbon connected to the oxygen is a secondary or tertiary carbon; R² is selected from a monovalent hydrocarbon group of 1 to 3 carbons; Z is a hydrophilic group of the general structure:

—R⁴O[CH₂CH₂O]ₘ[CH₂CH(R⁵)O]ₙR⁶

where R⁴ is a divalent hydrocarbon group of 2 to 6 carbons; R⁵ is methyl or ethyl; R⁶ is selected from H, a monovalent hydrocarbon group of 1 to 4 carbons, or —C(O)R⁷, where R⁷ is a monovalent hydrocarbon of 1 to 4 carbon atoms; m is 3 to 15; n is 0 to 8; and m+n is 6 to 18.

In one embodiment, the hydrocarbon having 4 to 8 carbons for R¹ and R³ are each independently selected from a branched hydrocarbon having 4 to 8 carbons.

In one embodiment, wherein the hydrocarbon having 4 to 8 carbons for R¹ and R³ are each independently selected from a branched hydrocarbon having 4 to 6 carbons.

In one embodiment, R¹ and R³ are each independently selected from a hydrocarbon having 4 to 8 carbon atoms. In one embodiment, R¹ and R³ are independently selected from butyl, isobutyl, tert-butyl, 2-methyl butyl, 2-ethyl butyl, 2,2-dimethyl butyl, 3,3-dimethyl butyl, 1,2-dimethylbutyl, 1,3-dimethylbutyl, 1,2,2-trimethylpropyl, 1,1,2-trimethylpropyl, pentyl, isopentyl, 1-methyl pentyl, 2-methyl pentyl, 3-methyl pentyl, 4-methyl pentyl, 2-ethyl pentyl, 3-ethyl pentyl, 1,2-dimethyl propyl, 1,1-dimethyl propyl, 3-propyl pentyl, 3,3-dimethyl propyl, hexyl, heptyl, and octyl. In one embodiment, R¹ and R³ are selected from, but are not limited to, 2-butyl, tert-butyl, 2-pentyl, 3-pentyl, 2-methyl-2-butyl, 4-methyl-2-pentyl, 3-methyl-3-pentyl, and 3-methyl-2-pentyl.

In one embodiment in accordance with any previous embodiment, n is 0.

In one embodiment in accordance with any previous embodiment, m is from about 4 to about 8, and n is from 0 to about 5.

In one embodiment in accordance with any previous embodiment, wherein R¹ and R³ are each independently selected from a branched hydrocarbon group of 4 to 8 carbons; R² is selected from a monovalent hydrocarbon group of 1 to 3 carbons; R⁴ is selected from a divalent hydrocarbon group of 2 to 6 carbons, R⁵ is selected from methyl or ethyl; R⁶ is selected from H, a monovalent hydrocarbon group of 1 to 4 carbons, or acetyl; m is from about 3 to about 15; n is 0 to about 8.

In one embodiment, R⁴ is selected from a branched hydrocarbon of 4 to 6 carbons.

In one embodiment, m is from about 4 to about 8.

In one embodiment, n is 0 to about 3.

In one embodiment in accordance with any previous embodiment, R¹ and R³ are independently selected from a branched hydrocarbon group of 4 to 8 carbons; R² is selected from a monovalent hydrocarbon group of 1 to 2 carbons; R⁴ is selected from a divalent hydrocarbon group of 3 to 4 carbons; R⁵ is methyl; R⁶ is H; m is 6 to 12; and n is 0.

In one embodiment in accordance with any previous embodiment, R¹ and R³ are independently selected from a branched hydrocarbon of 5 to 6 carbons; R² is methyl; R⁴ is selected from a divalent hydrocarbon group of 3 to 4 carbons; R⁵ is methyl; R⁶ is H; m is about 4 to 8; and n is 1 to 3.

In one embodiment in accordance with any previous embodiment, R¹ and R³ are independently selected from a branched hydrocarbon having 5 carbons; R² is selected from methyl or ethyl; R⁴ is selected from a divalent hydrocarbon having 3 to 4 carbons; R⁵ is methyl; R⁶ is selected from butyl or acetyl; m is about 6 to 15; and n is 0 to 2.

In one embodiment in accordance with any previous embodiment, R¹ and R³ are independently selected from a branched hydrocarbon group of 4 to 6 carbons; R² is methyl; R⁴ is selected from a divalent hydrocarbon group of 3 to 4 carbons; R⁵ is methyl; R⁶ is H; m is about 10 to 15; and n is 0 to 3.

In one embodiment in accordance with any previous embodiment, the composition has a GHS Class 2 acute aquatic toxicity and/or a GHS Class 3 acute toxicity for fish according to OECD Test Guideline 203.

In one embodiment in accordance with any previous embodiment, the composition has an Acute Oral LD50 of ≥2000 mg/Kg (Rat).

In one embodiment in accordance with any previous embodiment, the composition has ≥60% biodegradability in 28 days according to the OECD 301B method and/or the OECD 301F method. In one embodiment, the composition is classified as inherently, or ultimately or readily biodegradable according to the OECD 301B method and/or the OECD 301F method.

In one embodiment in accordance with any previous embodiment, the composition has a “Not Classified” status for toxicity.

In another aspect, provided is an agrochemical composition comprising the silane composition in accordance with any of the previous embodiments.

In one embodiment, the agrochemical composition comprises a herbicide, an insecticide, a growth regulator, a fungicide, a miticide, an acaricide, a fertilizer, a biological, a plant nutritional, a micronutrient, a biocide, a paraffinic mineral oil, a methylated seed oil, a vegetable oil, a water conditioning agent, a modified clay, a foam control agent, a surfactant, a wetting agent, a dispersant, an emulsifier, a deposition aid, an antidrift component, water, or a combination of two or more thereof.

In still another aspect, provided is a method of treating an agricultural area comprising applying the silane composition of any of the previous embodiments and an agrochemical material to an area within the agricultural area.

In one embodiment, the silane composition and the agrochemical material are provided as a mixture.

In one embodiment, the silane composition and the agrochemical material are separately provided, and the silane composition is added to the agrochemical material at the point of application.

In one embodiment, the silane composition is provided in an amount of from about 0.01 wt. % to about 5 wt. % at the point of use.

In yet another aspect, provide is a method of making a silane composition of any of claims 1-17 comprising:
reacting H—Si(R²)X₂ with R¹—OH and R³—OH to form a compound of the formula R¹OSi(R²)(H)OR³;
reacting the compound of the formula R¹OSi(R²)(H)OR³ with a compound of the formula: R^{4′}O[CH₂CH₂O]ₘ[CH₂CH(R⁵)O]ₙR⁶
where R¹ and R³ are each independently selected from a monovalent hydrocarbon having 4 to 8 carbons;
R² is selected from a monovalent hydrocarbon group of 1 to 3 carbons;
R^{4′} is selected from a hydrocarbon group with 2 to 6 carbon atoms and having an unsaturated carbon-carbon bond;
R⁵ is methyl or ethyl,
R⁶ is selected from H, a monovalent hydrocarbon group of 1 to 4 carbons, or —C(O)R⁷, where R⁷ is selected from a monovalent hydrocarbon of 1 to 4 carbon atoms; and
m is 3 to 15;
n is 0 to 8; and
m+n is 6 to 18.

The following description and the drawings disclose various illustrative aspects. Some improvements and novel aspects may be expressly identified, while others may be apparent from the description.

### DETAILED DESCRIPTION

Reference will now be made to exemplary embodiments, examples of which are illustrated in the detailed description. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Provided is a silane composition. The silane composition comprises a new silane that has found to exhibit low toxicity as well as biodegradability. The silane compositions are suitable for use as adjuvants for dispensing other materials such as agrochemicals. The compositions provide excellent spreading properties in addition to having low toxicity and being biodegradable.

The silane composition comprises a polyalkyleneoxide functional dialkoxyalkylsilane. As used herein the polyalkyleneoxide functional dialkoxyalkylsilane may also simply be referred to as a dialkoxy silane.

In one embodiment, the polyalkyleneoxide functional dialkoxyalkylsilane is a compound of the formula:

R¹OSi(R²)(Z)OR³ (I)
wherein:
R¹ and R³ are each independently selected from a hydrocarbon having 4 to 8 carbons, where the carbon connected to the oxygen is a secondary or tertiary carbon;
R² is selected from a monovalent hydrocarbon group of 1 to 3 carbons;
Z is a hydrophilic group of the general structure:

—R⁴O[CH₂CH₂O]ₘ[CH₂CH(R⁵)O]ₙR⁶
where R⁴ is a divalent hydrocarbon group of 2 to 6 carbons;
R⁵ is methyl or ethyl,
R⁶ is selected from H, a monovalent hydrocarbon group of 1 to 4 carbons, or —C(O)R⁷, where R⁷ is a monovalent hydrocarbon of 1 to 4 carbon atoms; and
m is from about 3 to about 15;
n is 0 to about 8; and
m+n is about 6 to about 18.

In one embodiment, R¹ and R³ are independently selected from butyl, isobutyl, tert-butyl, 2-methyl butyl, 2-ethyl butyl, 2,2-dimethyl butyl, 3,3-dimethyl butyl, 1,2-dimethylbutyl, 1,3-dimethylbutyl, 1,2,2-trimethylpropyl, 1,1,2-trimethylpropyl, pentyl, isopentyl, 1-methyl pentyl, 2-methyl pentyl, 3-methyl pentyl, 4-methyl pentyl, 2-ethyl pentyl, 3-ethyl pentyl, 1,2-dimethyl propyl, 1,1-dimethyl propyl, 3-propyl pentyl, 3,3-dimethyl propyl, hexyl, heptyl, and octyl. Examples of suitable groups for R¹ and R³ include, but are not limited to, those listed in Table A, which provides the hydrocarbon group as well as the corresponding branched alcohol group from which the R¹ and R³ are derived. In the structures in Table A, the “(—)” designation indicates a bond that would be connected to the oxygen atom in Formula (I).

TABLE
A-Description of R¹ and R³ branched hydrocarbon groups

| Hydrocarbon Group | Hydrocarbon Structure | Corresponding Alcohol |
|---|---|---|
| 2-butyl | CH3—CH2—CH(—)CH3 | 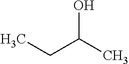 |
| tert-butyl | (CH3)3C— | 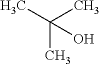 |
| 2-pentyl | CH3(CH2)2CH(—)(CH3) | 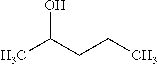 |
| 3-pentyl | (CH3CH2)2CH— | 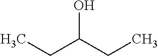 |
| 2-methyl-2butyl (t-Amyl) | CH3CH2C(—)(CH3)2 | 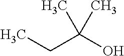 |
| 4-methyl-2-pentyl | (CH3)2CH—CH2—CH(—)(CH3) | 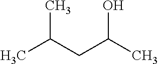 |
| 3-methyl-3-pentyl | CH3—CH2—C(—)(CH3)—CH2—CH3 | 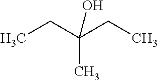 |
| 3-methyl-2-pentyl | CH3CH2CH(CH3)CH(—)(CH3) | 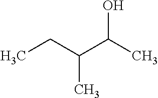 |
| 3-methyl-2-butanol | CH3—CH(CH3)—CH(—)—CH3 | 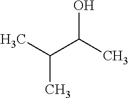 |

R² is selected from a monovalent hydrocarbon group having 1 to 3 carbon atoms. R² can be selected from methyl, ethyl, propyl, or isopropyl.

R⁴ is a divalent hydrocarbon group having 2 to 6 carbon atoms. R⁴ can have 2 to 6 carbon atoms, 3 to 5 carbon atoms, or 3 to 4 carbon atoms. In one embodiment, R⁴ is a divalent alkyl group having 3 carbon atoms.

In the group —R⁴O[CH₂CH₂O]ₘ[CH₂CH(R⁵)O]ₙR⁶, m can be selected from about 3 to about 15, about 4 to about 12, about 5 to about 10, or about 6 to about 8; and n can be selected from 0 to about 8, about 1 to about 6, or about 2 to about 5. It will be appreciated that m and n can be a real number (including a whole number or a decimal/fraction). In one embodiment, m is from about 4 to about 8, and n is 0 to about 5. In one embodiment, m is from about 4 to 8, and n is from about 2 to about 5.

In one embodiment, where n is greater than 0, the ration of m:n is from about 0.8 to about 2.8, from about 1 to about 2.8, or from about 1.9 to about 2.8. In one embodiment the ratio of m:n is from about 0.8 to about 2.8, from about 1 to about 2.5, from about 1.2 to about 2.2, from about 1.5 to about 2, or from about 1.6 to about 1.8.

In one embodiment, the dialkoxy silane is a compound of the general structure:

R¹OSi(R²)(Z)OR³ (I)
wherein:
R¹ and R³ are each independently selected from a branched hydrocarbon group having 4 to 8 carbons, where a carbon connected to the oxygen is a secondary or tertiary carbon;
R² is selected from a monovalent hydrocarbon group of 1 to 3 carbons, and in embodiments, 1 to 2 carbon atoms;
Z is an hydrophilic group of the general structure:

—R⁴O[CH₂CH₂O]ₘ[CH₂CH(R⁵)O]ₙR⁶
where R⁴ is a divalent hydrocarbon group of 2 to 6 carbons, including, but not limited to, a branched hydrocarbon of 4 to 6 carbons;
R⁵ is methyl or ethyl;
R⁶ is H, a monovalent hydrocarbon group of 1 to 4 carbons, or acetyl;
m is about 3 to about 15, and in embodiments about 4 to about 8;
n is 0 to about 8, and in embodiments 0 to about 3. In one embodiment, R¹ and R³ are independently selected from a branched hydrocarbon group having 4 to 8 carbons, where the carbon is connected to the oxygen is a tertiary carbon

In another embodiment the dialkoxy silane is a compound of the general structure

R¹OSi(R²)(Z)OR³
wherein:
R¹ and R³ are independently selected from a branched hydrocarbon group having 4 to 8 carbons, where the carbon connected to the oxygen is a secondary or tertiary carbon;
R² is selected from a monovalent hydrocarbon group of 1 to 2 carbons, and in one embodiment methyl;
Z is a hydrophilic group of the general structure:

—R⁴O[CH₂CH₂O]ₘ[CH₂CH(R⁵)O]ₙR⁶
where R⁴ is a divalent hydrocarbon group of 3 to 4 carbons, and in one embodiment a branched hydrocarbon group of 4 carbons;
R⁵ is methyl;
R⁶ is H;
m is 6 to 12; and
n is 0. In one embodiment, R¹ and R³ are independently selected from a branched hydrocarbon group having 4 to 8 carbons, where the carbon is connected to the oxygen is a tertiary carbon

In one embodiment, the dialkoxy silane is of the general structure

R¹OSi(R²)(Z)OR³
R¹ and R³ are independently selected from a branched hydrocarbon of 5 to 6 carbons, where the carbon connected to the oxygen is a secondary or tertiary carbon;
R² is methyl;
Z is a hydrophilic group of the general structure

—R⁴O[CH₂CH₂O]ₘ[CH₂CH(R⁵)O]ₙR⁶
where R⁴ is a divalent hydrocarbon group of 3 to 4 carbons;
R⁵ is methyl;
R⁶ is H;
m is about 4 to 8; and
n is 1 to 3. In one embodiment, R¹ and R³ are independently selected from a branched hydrocarbon group having 4 to 6 carbons, where the carbon connected to the oxygen is a tertiary carbon

In one embodiment, the dialkoxy silane is a compound of the general structure

R¹OSi(R²)(Z)OR³
where R¹ and R³ are independently selected from a branched hydrocarbon having 5 carbons, where the carbon connected to the oxygen is a secondary or tertiary carbon;
R² is methyl or ethyl;
Z is a hydrophilic group of the general structure:

—R⁴O[CH₂CH₂O]ₘ[CH₂CH(R⁵)O]ₙR⁶
where R⁴ is a divalent hydrocarbon having 3 to 4 carbons;
R⁵ is methyl;
R⁶ is butyl or acetyl;
m is about 6 to 15; and
n is 0 to 2. In one embodiment, R¹ and R³ are independently selected from a branched hydrocarbon group having 5 carbons, where the carbon is connected to the oxygen is a tertiary carbon.

In one embodiment, the dialkoxy silane surfactant is a compound of the general structure

R¹OSi(R²)(Z)OR³
where R¹ and R³ are independently selected from a branched hydrocarbon group of 4 to 6 carbons, where the carbon connected to the oxygen is a secondary or tertiary carbon;
R² is methyl;
Z is a hydrophilic group of the general structure:

—R⁴O[CH₂CH₂O]ₘ[CH₂CH(R⁵)O]ₙR⁶
where R⁴ is a divalent hydrocarbon group of 3 to 4 carbons;
R⁵ is methyl;
R⁶ is H;
m is about 10 to 15; and
n is 0 to 3. In one embodiment, R¹ and R³ are independently selected from a branched hydrocarbon group having 4 to 6 carbons, where the carbon connected to the oxygen is a tertiary carbon

The present dialkoxy silanes can be produced by reacting a dialkoxysilane hydride with an olefinically modified polyalkyleneoxide via hydrosilylation reaction techniques.

The process may include reacting a dihalo silylhydride with molar excess of an alcohol to produce a dialkoxysilane hydride. The process for forming the dialkoxysilane hydride may be illustrated as follows:

H—Si(R²)X₂+R¹—OH+R³—OH→R¹OSi(R²)(H)OR³

where X is Cl, Br, or I, and R¹, R³, and R² are as described above. In embodiments, X is selected from Cl such that the dihalo silylhydride is a dichlorosilylhydride.

The reaction may be carried out in the presence of a scavenger to scavenge the halogen atoms. The reaction may be carried out in a solvent, or the reaction may be solventless. Examples of suitable solvents include, but are not limited to, hexane, cyclohexane, toluene, xylene, isopropyl ether, hexane, heptane, pentane, isooctane, isopropylether, ethyleneglycol dibutyl ether, and the like. Examples of suitable halogen scavengers include, but are not limited to, methylimidazole, imidazole, tributylamine, ethylenediamine, 1,3-diaminopropane, diethylenetriamine, and the like.

The process for producing the polyalkyleneoxide modified dialkoxy alkyl silane may be accomplished by hydrosilylation reactions as are known in the art. An olefinically modified polyalkyleneoxide is reacted with the dialkoxysilane hydride. The olefinically modified polyalkyleneoxide may be a compound of the formula:

R^{4′}O[CH₂CH₂O]ₘ[CH₂CH(R⁵)O]ₙR⁶

where R⁵, R⁶, and subscripts m and n are as previously defined, and R^{4′} is a hydrocarbon group with 3 to 4 carbon atoms and having an unsaturated carbon-carbon bond.

Examples of suitable olefinically modified polyethers include, but are not limited to, polyethyleneglycol allylether, polyethyleneglycol polypropyleneglycol allylether, methoxy polyethyleneglycol allylether, methoxy polyethyleneglycol polypropyleneglycol allylether, butoxy polyethyleneglycol polyproplylene glycol allylether, methoxy polypropyleneglycol allylether, polyethyleneglycol polypropyleneglycol polybutyleneglycol allylether, polyethleneglycol polybutyleneglycol allylether, polyethyleneglycol polypropyleneglycol polybutyleneglycol allylether, mixtures of two or more, and the like. The olefinically modified polyalkyleneoxides may be random or block type polymers.

The reaction may be carried out under catalytic hydrosilylation reaction conditions to provide a polyether-modified dialkoxy methylsilane surfactant compounds of the invention. The reaction may be carried out employing any techniques and components suitable for carrying out hydrosilylation reactions. Hydrosilylation reactions are typically conducted with a hydrosilylation catalyst. The type of catalyst is not particularly limited and any catalyst suitable for catalyzing a hydrosilylation reaction may be employed. Hydrosilylation catalysts may be selected from complexes of metals such as rhodium, ruthenium, palladium, osmium, iron, iron, iridium, platinum, and the like.

Conventional hydrosilylation catalysts include Pt-based catalysts such as Karstedt's, Speier, or Lamaroeux catalysts, as well as with free radical generators and metal carbonyls assisted with UV-VIS irradiation. Suitable hydrosilylation catalysts include, but are not limited to, those having the formula PtCl₂ olefin and HPtCl₃ olefin as described in U.S. Pat. No. 3,159,601, hereby incorporated by reference. Other platinum-containing hydrosilylation catalysts include complexes of chloroplatinic acid with up to 2 moles per gram of platinum and an alcohol, ether, aldehyde and mixtures thereof as described in U.S. Pat. No. 3,220,972, hereby incorporated by reference. Additional platinum-containing hydrosilylation catalysts useful in preparing the present polyether-modified dialkoxyalkylsilane include, but are not limited to, those described in U.S. Pat. Nos. 3,715,334, 3,775,452 and 3,814,730 (Karstedt's catalyst), each of which is hereby incorporated by reference in its entirety. The catalyst can be provided in any suitable amount to facilitate the reaction. In embodiments, the catalyst can be used in an amount of from about 0.1 to about 50 parts per million based on the total weight of the composition for forming the polyalkyleneoxide modified silane.

During the reaction to form the dialkoxy silane, it is possible that a small amount of a dimer may be formed, which would have a siloxane linkage. Generally, the amount of any dimer formed during the process is relatively low and on the order of less than 10%, less than 7% less than 5%, less than 3%, less than 1%, less than 0.1%. In embodiments, there is from about 0 to about 10%, 0 to about 5%, or 0 to about 3% of dimer present.

The present silane compositions exhibit biodegradability. In one embodiment, the silane compositions may be considered “Readily Biodegradable” according to OECD 301B and/or OECD 301F methods. Biodegradability of spray adjuvants is beneficial in that biodegradability contributes to sustainability and reducing the potential for persistence of these materials in the environment.

In another embodiment, the silane compositions may be considered as inherently or ultimately biodegradable and has ≥60% biodegradability in 28 days according to the OECD 301B method and/or the OECD 301F.

The present silane compositions may also have low toxicity profiles. In one embodiment, the silane composition has at least a GHS Class 2 or 3 acute toxicity for fish according to OECD Test Guideline 203 (96h-LC50 (test species).

Agricultural sprays containing adjuvants have the potential to get into surface water (ponds, streams, lakes, etc.), and it is an added benefit for adjuvants to have low toxicity so as to minimize any potential for a negative impact on aquatic life (such as, but not limited to, fish). In one embodiment, the silane composition has an Acute Oral LD50 of ≥2000 mg/Kg (Rat).

The present alkyleneoxide functional dialkoxy silanes can be employed as an adjuvant in an agrochemical composition comprising one or more agrochemical ingredients. Many agrochemical applications require the addition of an adjuvant to the spray mixture to provide wetting and spreading on foliar surfaces. Often that adjuvant is a surfactant, which can perform a variety of functions, such as increasing spray droplet retention on difficult to wet leaf surfaces, enhance spreading to improve spray coverage, or to provide penetration of the herbicide into the plant cuticle. These adjuvants are provided either as a tank-side additive or used as a component in pesticide formulations. The present alkyleneoxide functional dialkoxy silanes have been found to provide the benefit of spreading comparable to or better than conventional adjuvants (such as trialkoxysilanes). Further, the present silanes exhibit low toxicity and are readily biodegradable.

In an agrochemical composition, the silane composition can be employed in an amount as desired for a particular purpose or intended application. In embodiments, the silane composition can be employed either as part of an agrochemical formulation, or added directly to a spray mixture at point of use with agrochemical sprays. When provided as part of an agrochemical formulation with an agrochemical, the silane composition can be provided in any suitable concentration that will allow for providing the silane composition in a desired amount, as discussed further below, when the agrochemical composition is diluted prior to application to an agricultural area.

The silane composition will generally be provided to the target agricultural material or area, either as part of an agrochemical composition or separately provided, in an amount, upon dilution in water, at a use level of from about 0.01 wt. % to about 5 wt. %, from about 0.1 wt. % to about 4 wt. %, from about 0.5 wt. % to about 3 wt. %, or from about 1 wt. % to about 2 wt. %. In one embodiment, the silane composition can be employed to in an amount, upon dilution in water, at a use level of from about 0.01 wt. % to about 1 wt. %, from about 0.05 wt. % to about 0.75 wt. %, from about 0.1 wt. % to about 0.5 wt. %, from about 0.15 wt. % to about 0.4 wt. %, or from about 0.2 wt. % to about 0.3 wt. %.

Suitable agrochemical ingredients include, but not limited to, herbicides, insecticides, growth regulators, fungicides, miticides, acaricides, fertilizers, biologicals, plant nutritionals, micronutrients, biocides, paraffinic mineral oil, methylated seed oils (i.e. methylsoyate or methylcanolate), vegetable oils (such as soybean oil and canola oil), water conditioning agents, modified clays, foam control agents, surfactants, wetting agents, dispersants, emulsifiers, deposition aids, antidrift components, and water. In one embodiment, the composition may optionally comprise additional surfactants (co-surfactants). Co-surfactants useful in the compositions herein include nonionic, cationic, anionic, amphoteric, zwitterionic, polymeric surfactants, or any mixture thereof. Surfactants are typically hydrocarbon based or silicone based (i.e. trisiloxane alkoxylate such as Silwet 408, or Silwet 806 to name a few). Moreover, other co-surfactants, that have short chain hydrophobes that do not interfere with superspreading as described in U.S. Pat. No. 5,558,806 herein incorporated by reference are also useful.

Examples of suitable co-surfactant materials include, but are not limited to, alkoxylates, especially ethoxylates, containing block copolymers including copolymers of ethylene oxide, propylene oxide, butylene oxide, and mixtures thereof; alkylarylalkoxylates, especially ethoxylates or propoxylates and their derivatives including alkyl phenol ethoxylate; arylarylalkoxylates, especially ethoxylates or propoxylates, and their derivatives; amine alkoxylates, especially amine ethoxylates; fatty acid alkoxylates; fatty alcohol alkoxylates; guerbet alcohol alkoxylates, Alcohol alkyl sulfonates; alkyl benzene and alkyl naphthalene sulfonates; sulfated fatty alcohols, amines or acid amides; acid esters of sodium isethionate; esters of sodium sulfosuccinate; sulfated or sulfonated fatty acid esters; petroleum sulfonates; N-acyl sarcosinates; alkyl polyglycosides; alkyl ethoxylated amines; and the like.

Specific examples include, but are not limited to, alkyl acetylenic diols (SURFONYL—Evonik), 2-ethyl hexyl sulfate, isodecyl alcohol ethoxylates (e.g., RHODASURF DA 530—Solvay), ethylene diamine alkoxylates (TETRONICS—BASF), ethylene oxide/propylene oxide copolymers (PLURONICS—BASF), Gemini type surfactants (Solvay) and diphenyl ether Gemini type surfactants (e.g. DOWFAX—Dow Chemical). Other particularly useful surfactants include, but are not limited to, ethylene oxide/propylene oxide copolymers (EO/PO); amine ethoxylates; alkyl polyglycosides; oxo-tridecyl alcohol ethoxylates, and the like.

In embodiments employing a co-surfactant, the composition may comprise from about 10% to about 99.9% of a silane of formula (I) and from about 0.1% to about 90% of co-surfacnt, from about 20% to about 90% of a silane of formula (I) and from about 10% to about 80% of co-surfacnt, from about 25% to about 80% of a silane of formula (I) and from about 20% to about 75% of co-surfacnt, from about 30% to about 70% of a silane of formula (I) and from about 30% to about 70% of co-surfacnt, from about 40% to about 60% of a silane of formula (I) and from about 40% to about 60% of co-surfacnt based on the total weight of silane of formula (I) and co-surfactant. In one embodiment, the composition comprises about 50% of a silane of formula (I) and about 50% of co-surfacnt based on the total weight of silane of formula (I) and co-surfactant.

The term “pesticide” herein means any compound used to destroy pests, e.g., rodenticides, insecticides, miticides, fungicides, herbicides, and the like. Typical uses for pesticides include agricultural, horticultural, turf, ornamental, home and garden, veterinary and forestry applications. The pesticidal formulations of the present invention also include at least one pesticide. Optionally, the pesticidal formulation may include excipients, cosurfactants, solvents, foam control agents, deposition aids, drift retardants, biologicals, micronutrients, fertilizers, and the like. Illustrative examples of pesticides that can be employed include, but are not limited to mitotic disrupters, lipid biosynthesis inhibitors, cell wall inhibitors, and cell membrane disrupters. The amount of pesticide employed in agrochemical formulations may vary with the type of pesticide employed. More specific examples of pesticide compounds that can be used with the formulations include, but are not limited to, herbicides and growth regulators such as phenoxy acetic acids, phenoxy propionic acids, phenoxy butyric acids, benzoic acids, triazines and s-triazines, substituted ureas, uracils, bentazon, desmedipham, methazole, phenmedipham, pyridate, amitrole, clomazone, fluridone, norflurazone, dinitroanilines, isopropalin, oryzalin, pendimethalin, prodiamine, trifluralin, glyphosate, sulfonylureas, imidazolinones, dethodim, diclofop-methyl, fenoxaprop-ethyl, fluazifop-p-butyl, haloxyfop-methyl, quizalofop, sethoxydim, dichlobenil, isoxaben, and bipyridylium compounds.

Fungicide compositions that can be used with the present invention include, but are not limited to, aldimorph, tridemorph, dodemorph, dimethomorph; flusilazol, azaconazole, cyproconazole, epoxiconazole, furconazole, propiconazole, tebuconazole and the like; imazalil, thiophanate, benomyl carbendazim, chlorothialonil; dieloran, trifloxystrobin, fluoxystrobin, dimoxystrobin, azoxystrobin, furcaranil, prochloraz, flusulfamide, famoxadone, captan, maneb, mancozeb, dodicin, dodine, and metalaxyl.

Insecticides, including larvacide, miticide and ovacide compounds that can be used with the composition of the present invention include, but are not limited to, Bacillus thuringiensis, spinosad, abamectin, doramectin, lepimectin, pyrethrins, carbaryl, primicarb, aldicarb, methomyl, amitraz, boric acid, chlordimeform, novaluron, bistrifluron, triflumuron, diflubenzuron, imidacloprid, diazinon, acephate, endosulfan, kelevan, dimethoate, azinphos-ethyl, azinphos-methyl, izoxathion, chlorpyrifos, clofentezine, lambda-cyhalothrin, permethrin, bifenthrin, cypermethrin, and the like.

Fertilizers, and micronutrients include, but are not limited to, zinc sulfate, ferrous sulfate, ammonium sulfate, urea, urea ammonium nitrogen, ammonium thiosulfate, potassium sulfate, monoammonium phosphate, urea phosphate, calcium nitrate, boric acid, potassium and sodium salts of boric acid, phosphoric acid, magnesium hydroxide, manganese carbonate, calcium polysulfide, copper sulfate, manganese sulfate, iron sulfate, calcium sulfate, sodium molybdate, calcium chloride, or a combination of two or more thereof.

Biologicals may include microbial and naturally derived additives that provide protection to a crop or plant. These may include essential oils (botanials), products of bio-fermentation, plant extracts, and the like. Some examples of biologicals include biostimulants, bioinhibitors, biofungicides, bioinsecticides, spinosads, and the like. Biologicals may be provided in any suitable form or from any suitable biological source. In embodiments, biologicals may be derived from microbial products such as, but not limited to, fermentation products (i.e. spinosids), or as microorganisms.

Examples of biostimulants or bioinhibitors, include, but are not limited to, enzymes, proteins, amino acids, micronutrients, salicylic acid, humic and fulvic acids, or protein hydrolases, and the like.

Examples of suitable biofungicides include, but not limited to, Trichoderma (e.g. Trichoderma harzianum), Bacillus subtilis, Bacillus amyloliquefaciens, Bacillus amyloliquefaciens, Bacillus subtilis, Trichoderma harzianum, and Streptomyces lydicus, and the like. One example of a biofungicide is Bacillus amyloliquefaciens strain MBI 600, Serifel® from BASF.

Examples of bioinsecticides include, but not limited to, Bacillus thuringiensis (BT), Burkholderia spp. (e.g. Venerate—Marrone), Chromobacterium subtsugae (e.g. Grandevo—Marrone), Isaria fumosorosea, Beauveria bassiana, Metarhizum anisopliae, and the like.

Examples of spinosads include, but are not limited to, Saccharopolyspora spinose, and the like.

Examples of botanicals include, but are not limited to, Pyrethrins, Botanical Oils (e.g. capsicum oleoresin extract, garlic oil, d-limonene, geraniol, cinnamon oil, ginger oil, clove oil, lavender oil, oregano oil, tea tree oil, fennel oil, thyme oil, rosemary oil, neem oil (neem extracts), and the like.

It will be appreciated that biopesticide actives may include, but are not limited to, those listed by EPA at https://www.epa.gov/ingredients-used-pesticide-products/biopesticide-active-ingredients.

Suitable agrochemical compositions are made by combining, in a manner known in the art, such as, by mixing one or more of the above components with the present silane composition, either as a tank-mix, or as an “In-can” formulation. The term “tank-mix” means the addition of at least one agrochemical to a spray medium, such as water or oil, at the point of use. The term “In-can” refers to a formulation or concentrate containing the silane composition and at least one agrochemical component. The “In-can” formulation may then diluted to use concentration at the point of use, typically in a Tank-mix, or it may be used undiluted.

The agrochemical compositions are not limited to use with a particular type of soil or with respect to the types of crops or vegetation to be grown within the area of land to be treated with agrochemical composition.

The agrochemical compositions employing the present silane compositions, methods of using such compositions, etc., can be employed to treat areas where a variety of crops, plants, etc., may be grown. Examples of suitable crop plants whose production and growth may be enhanced by the use of the present silane compositions, alone or in conjunction with fertilizers, nutrients, etc., include, but are not limited to, cereals, for example wheat, rye, barley, triticale, oats, rice, etc.; beet, for example sugar, fodder beet, etc.; pome fruit, stone fruit, and soft fruit, for example apples, pears, plums, peaches, almonds, cherries, strawberries, raspberries, currants, goose-berries, etc.; legumes, for example beans, lentils, peas, lucerne, soybeans, etc.; oil crops, for example oilseed rape, mustard, olives, sunflowers, coconut, cacao, castor beans, oil palm, peanuts, soybeans, etc.; cucurbits, for example pumpkins/squash, cucumbers, melons, etc.; fiber crops, for example cotton, flax, hemp, jute, etc.; citrus fruit, for example oranges, lemons, grapefruit, tangerines, etc.; vegetable plants, for example spinach, lettuce, asparagus, cabbages, carrots, onions, tomatoes, eggplant, potatoes, pumpkin/squash, radish, capsicums, etc.; plants of the laurel family, for example avocados, cinnamon, camphor, etc.; plants of the ginger family, for example, ginger, turmeric, cardamom, galangal, etc.; energy crops and industrial feedstock crops, for example maize, soybeans, wheat, oilseed rape, sugar cane, oil palm, etc.; maize; tobacco; nuts; coffee; tea; bananas; wine (dessert grapes and grapes for vinification); hops; grass, for example turf; sweetleaf (Stevia rebaudania); rubber plants, and forest plants, for example flowers, shrubs, deciduous trees, and coniferous trees, and propagation material, for example seeds, and harvested produce of these plants.

Aspects and embodiments of the present technology may be further understood with respect to the following examples. The examples are not intended to be limiting of any particular aspect of the invention.

### Examples

### Dialkoxy Alkylsilane Preparation

Dialkoxy alkylsilanes were prepared by reacting a dichloromethylsilane with a selected alcohol. The reaction was conducted in the presence of an organic base. The preparation of diamyloxy methyl silane is described below.

Diamyloxy methylsilane was prepared by reacting dichloromethylsilane with 2-methyl-2-butanol in a four-neck 1000 mL flask equipped with an overhead stirrer, dropping funnel and a N₂ inlet. 193 g (2.347 mole) of 1-methyl imidazole and 206.9 g (2.347 mole) of 2-methyl-2-butanol (30 to 40% excess), and hexane were charged to a four-neck 1000 mL flask. The flask contents were mixed at room temperature, under N₂. The mixture was then cooled to 0° C., at which point 81.5 mL of dichloromethylsilane (0.782 moles) was added dropwise from an addition funnel over a 2 hour time interval, and the reaction temperature was maintained to below 20° C. After the dichloromethylsilane addition was completed, the ice bath was removed and the flask was allowed to come to room temperature, after which the temperature was then increased to 60° C. The reaction temperature was kept at 60° C. for 2 hours. 250 mL of deionized (DI) water was then added to the flask and stirred for 10 minutes to dissolve the imidazolium salt formed during the reaction. The material was then washed six times with DI water. The alkoxy silane in the hexane and water mixture was separated using a separating funnel, and the water layer was removed. 25 g Na₂SO₄ (drying agent) was added to the remaining hexane phase and stirred for 5 to 10 minutes to remove the moisture from hexane alkoxy silane mixture.

The dialkoxy silane and hexane mixture was then filtered, and the hexane was removed using a rotary evaporator. The dialkoxy silane was then mixed with 4 g silica powder and stirred for 15 minutes at room temperature to remove any impurities and then filtered to remove the silica.

The final yield was greater than 94% (GC).

Other dialkoxy methylsilanes were made according to the above procedure using the same ratio of dichloromethylsilane:Alcohol:1-methyl-imidazole base (1:3:3). Dialkoxy methylsilanes were prepared using the following alcohols: 2-propanol, t-butanol, t-amyl alcohol, and 3-methyl-3-pentanol. The dialkoxy, methylsilane are designated as (DAMSi) and are hydride functional compounds that are employed to make the alkyleneoxide functional dialkoxyalkylsilane compounds. In all cases, the dialkoxy silane hydride yield was more than 90%, with a purity, by gas chromatography (GC) of greater 95%, and with less than 2% dimer. Table 1 list the dialkoxy methylsilanes employed in the examples.

TABLE 1

| ID | No. Carbons | R¹ & R³ | Silane mw |
|---|---|---|---|
| DMASi-1 | 3 | 2-propyl | 158.3 |
| DMASi-2 | 4 | t-butyl | 186.3 |
| DMASi-3 | 5 | t-amyl | 214.4 |
| DMASi-4 | 6 | 3-methyl-3-pentyl | 242.4 |

### Preparation of a Dialkoxy Silane Using Different Organic Bases

The dialkoxyalkylsilane can also be prepared in the presence of other organic base such as, but not limited to, ethylene diamine, hexamethyl diamine, triethyl amine, and the like.

Table 2 provides the charges and conditions as an illustrative example, where diamyloxy methylsilane was prepared by reacting dichloromethylsilane (DCMS) with 2-methyl-2-butanol in a four-neck 500 mL flask equipped with an overhead stirrer, dropping funnel and a N₂ inlet. Charged 30 g (0.5 mole) of ethylene diamine and 114.9 g (1.304 mole) of 2-methyl-2-butanol and hexane (30% excess) to a four-neck 500 mL flask. The solution was mixed at room temperature under N₂. The mixture was then cooled to 0° C. using an ice bath.

TABLE 2
Diamyloxy methylsilane

| | Dichloro- | 2 methyl- | Ethylene | |
|---|---|---|---|---|
| | methylsilane | 2-butanol | diamine | Hexane |
| Molecular Wt | 115.03 | 88.15 | 60.1 | 40% of |
| Wt./g | 50 | 114.9 | 30 | total |
| Moles | 0.435 | 1.304 | 0.5 | reactants |
| Equiv. | 1 | 3 | 1.15 | |
| Density | 1.105 | 0.805 | 0.899 | |
| Volume/mL | 45.25 | 142.73 | 33.37 | |
| Temperature | 0-20 degree C. | | | |

45.25 mL of dichloromethylsilane (0.435 moles) was charged to a dropping funnel and was added dropwise to the reaction mixture, over the time interval of 1 hour, while maintaining the reaction temperature below 20° C. After the addition was completed, the ice bath was removed and the flask allowed to come to room temperature, at which point the temperature was increased to 60° C. The reaction temperature was kept at 60° C. for 2 hour. 100 mL of DI water was added to the flask and stirred for 10 min to dissolve the amine-salt formed during the reaction. The material was then washed five times with DI water, where the alkoxy silane in hexane and water mixture was separated using separating funnel. The residual moisture was removed from the hexane/alkoxy silane mixture by adding 15 g Na₂SO₄, which was stirred for 5 to 10 minutes. The dialkoxy silane and hexane mixture was filtered to remove the solids, and the hexane was remove using a rotary evaporator. The dialkoxy silane was then mixed with 2 g silica powder and stirred for 15 minutes at room temperature to remove any impurities, at which point the silica was removed by filtration to yield the dialkoxy, methyl silane intermediate of the present invention.

Similarly, other organic bases were used in the preparation of the dialkoxy, methylsilanes (DAMSi) of the present invention. Table 3 provides the conditions for alternative bases, keeping in mind that the dichloromethylsilane to organic base ratio will change depending on the equivalents of amine contained in the base. This ratio will vary between 1:1.5 to 1:1.3 (silane/base) depending on the base used.

Table 3 also shows that preparations made with the various organic basses gave high product yield (>90%), when the solvent/silane/water mixture easily phase separated. When the mixture contained triethylamine as the base, a stable emulsion was formed resulting in the yield of the desired hydride being less than 90%.

TABLE 3

| | | 1-methyl | | Hexamethyl | Ethylene |
|---|---|---|---|---|---|
| Base | Triethylamine | imidazole | Imidazole | Diamine | diamine |
| Base presence with final | Yes | No | No | No | No |
| product (By GC-MS) | | | | | |
| DCMS:Alcohol:Base | 1:3:3 | 1:3:3 | 1:3:3 | 1:3:1.25 | 1:3:1.15 |
| Phase-Separation of | No | Yes | Yes | Yes | Yes |
| Solvent and Aqueous | | | | | |
| Phase? | | | | | |
| Oligomer % (By GC-MS) | 3-4% | 1-2% | 1-2% | 10% | 2% |
| Product Yield (%) | 68 | 94 | 95 | 91 | 96 |

### Preparation of Alkyleneoxide Functional Dialkoxyalkylsilanes

Alkyleneoxide functional dialkoxyalkylsilanes silane surfactants are prepared by reacting the dialkoxymethylsilanes prepared above with an olefinically modified alkylene oxide. Various alkyleneoxide functional dialkoxyalkylsilanes were prepared according Table 4 using the indicated dialkoxymethyl silane (DAMSi) having R¹ and R³ described in Table 1 with an olefinically modified polyalkylene oxide having the indicate Z group.

TABLE 4

| | | R¹ & R³ No. | | | | |
|---|---|---|---|---|---|---|
| | | of | Z | | | |
| ID | Silane Used | Carbons | M | n | R⁴ | R⁶ |
| SIL-1 | DAMSi -1 | 3 | 8 | 0 | 3 | CH3 |
| SIL-2 | DAMSi -2 | 4 | 8 | 0 | 3 | H |
| SIL-3 | DAMSi -3 | 5 | 8 | 0 | 3 | CH3 |
| SIL-4 | DAMSi -4 | 6 | 8 | 0 | 3 | CH3 |
| SIL-5 | DAMSi -2 | 4 | 8 | 0 | 3 | H |
| SIL-6 | DAMSi -2 | 4 | 5 | 2.5 | 3 | H |
| SIL-7 | DAMSi -2 | 4 | 4.7 | 4.9 | 3 | H |
| SIL-8 | DAMSi -3 | 5 | 8 | 0 | 3 | H |
| SIL-9 | DAMSi -3 | 5 | 5 | 2.5 | 3 | H |
| SIL-10 | DAMSi -3 | 5 | 4.7 | 4.9 | 3 | H |
| SIL-11 | DAMSi -4 | 6 | 8 | 0 | 3 | H |
| SIL-12 | DAMSi -4 | 6 | 5 | 2.5 | 3 | H |
| SIL-13 | DAMSi -4 | 6 | 4.7 | 4.9 | 3 | H |

### Comparative Surfactants

Trisiloxane alkoxylate surfactants were provided as comparative examples. The trisiloxane alkoxylate surfactants have the structure:

(CH₃)₃Si—O—Si(M)(CH₃)—O—Si(CH₃)₃ (VII)

where M is:

R⁴O[CH₂CH₂O]ₘ[CH₂CH(R⁵)O]ₙR⁶ (VIII)

The comparative surfactants are described in Table 5.

TABLE 5

| ID | Description | m | n | R⁴ | R⁵ | R⁶ |
|---|---|---|---|---|---|---|
| TSA-1 | Trisiloxane alkoxylate | 8 | 0 | 3 | H | H |
| TSA-2 | Trisiloxane alkoxylate | 5 | 2.5 | 3 | CH₃ | H |

### Physical Properties of Silane Surfactant Compositions

Table 6 shows that as the number of carbons in R^{1,3} increased, there was a corresponding decrease in cloud point. The aqueous surface tension decreased from 36.2 mN/in (R^{1,3} was isopropyl), to a minimum of 23.9 mN/m (R^{1,3} was t-butyl), before increasing once again as the carbon number increased. This may allow for controlling the solubility and surface tension properties depending on the R^{1,3} group composition as well as the polyalkyleneoxide. Additionally, the surface tension of the various Silane Surfactants was lower than a conventional nonionic surfactant, Trinton X-100 (NIS-1), with the exception that SIL-1 (where R¹ and R³ are C3) was higher.

For the analysis of the physical properties, the polyalkyleneoxide group contained in the present silane compounds was the same for all four compositions (m=8, n=0; SIL-1 through SIL-4). The only structural difference was that R⁶ in SIL-2, was hydrogen, while it is methyl in SIL-1, SIL-3, and SIL-4.

TABLE 6

| | | | | | Cloud | Surface |
|---|---|---|---|---|---|---|
| | | No. | Capping | | Point | Tension |
| | Silane | Carbons | Group | | (0.1%, | (0.1 wt %) |
| ID | Intermediate | (in R^{1, 3}) | (R⁶) | MW | ° C.) | (mN/m) |
| SIL-1 | DAMSi-1 | 3 | Me | 574 | >100 | 36.2 |
| SIL-2 | DAMSi-2 | 4 | H | 616 | 64 | 23.9 |
| SIL-3 | DAMSi-3 | 5 | Me | 629 | 28 | 25.7 |
| SIL-4 | DAMSi-4 | 6 | Me | 629 | <20 | 27.0 |
| NIS-1 | NA | NA | H | nd | 66 | 33* |

*Literature value from Triton X-100 technical data sheet (1%).

### Spreading Properties

Spreading was determined on an artificial surface using between 0.1% and 0.6% surfactant. The silane solutions were prepared in deionized water that was further purified with a Milli-Q ultrapure filtration system (Millipore Corp.). Thereafter, using a micro-pipette, a 10 μL drop was placed on a polystyrene surface (Petri-dish) and the spread diameter measured (mm) after 30 seconds, while maintaining a relative humidity between 35 and 70%).

Table 7 illustrates that the present silane compositions (SIL-2 to SIL-4) give an increase in spread diameter relative to NIS-1. Additionally, NIS-1 could not achieve a comparable level of spreading even at the highest concentration tested, which is above the typical use rate for spray adjuvants (between 0.1% and 0.5%).

TABLE 7

| | | No. | | | | |
|---|---|---|---|---|---|---|
| ID | R^{1, 3} | Carbons | 0.10% | 0.20% | 0.40% | 0.60% |
| NIS-1 | NA | NA | 7 | 8 | nd | 7 |
| SIL-1 | 2-propyl | 3 | 7 | 7 | 7 | 9 |
| SIL-2 | t-butyl | 4 | 8 | 10 | 20 | 39 |
| SIL-3 | t-amyl | 5 | 33 | 38 | 39 | 34 |
| SIL-4 | 3-methyl- | 6 | 14 | 18 | 28 | 35 |
| | 3-pentyl | | | | | |

### Effect of Polyalkyleneoxide Groups on Spreading

Spreading properties of polyalkyleneoxide functional dialkoxyalkyl silanes in accordance with the present technology with different polyalkyleneoxide groups were evaluated, and are shown in Table 8. The results illustrated in Table 8 indicate that the level of spreading may be controlled by balancing the type of alkoxy groups (R¹ and R³) and the polyalkyleneoxide group. As shown in Table 8, spreading typically decreased within a set as the number of carbons in the polyalkyleneoxide group increased.

TABLE 8

| | R¹ & R³ | | | | | |
|---|---|---|---|---|---|---|
| | No. of | Z | | Spread Diameter (mm) | | |
| ID | Carbons | M | n | 0.10% | 0.20% | 0.40% |
| SIL5 | 4 | 8 | 0 | 8 | nd | 27 |
| SIL6 | 4 | 5 | 2.5 | 6 | 8 | 9 |
| SIL7 | 4 | 4.7 | 4.9 | 5 | 5 | 5 |
| SIL8 | 5 | 8 | 0 | 18.3 | nd | 41.8 |
| SIL9 | 5 | 5 | 2.5 | 9 | 12 | 16 |
| SIL10 | 5 | 4.7 | 4.9 | 7.5 | 12.3 | 26.3 |
| SIL11 | 6 | 8 | 0 | 24.5 | nd | 37.0 |
| SIL12 | 6 | 5 | 2.5 | 19 | 36 | 44 |
| SIL13 | 6 | 4.7 | 4.9 | 6.8 | 7.5 | 8.5 |

Spreading Evaluation for Different R¹ and R³ Groups

Additional alkoxy silane surfactants were prepared according to the procedure outlined above, but in this case, using various secondary alcohols (Table 14, compositions of the present invention: SIL-14 to SIL-18) as the R¹ and R³ alkoxy groups. All of the alkoxy silane surfactants had the same polyether group (Z), which contained about 8 ethyleneoxide units, OH terminated as described below (Structure I).

R¹OSi(R²)(Z)OR³ (I)
Where,
Z is —R⁴O[CH₂CH₂O]ₘ[CH₂CH(R⁵)O]ₙR⁶; R⁴ is —CH₂CH₂CH₂—; m=8, n=0 and R⁶ is H. R¹ and R³ are defined below.

This example demonstrates the spreading capabilities the dialkoxy silane surfactants, when derived from a secondary alcohol. Therefore, 0.4% solutions of the desired dialkoxy silane surfactants were prepared at 0.4% in deionized water containing 10% buffer solution. For pH 5=X M+Y M, and for pH 7=XM+YM.

Table 9 shows that the compositions of the present invention (SIL-14 through SIL-18, based on a secondary alkoxide) along with SIL-8 (based on a tertiary alkoxide) provide an enhancement in spreading

TABLE 9
Spreading vs. Time at pH 7 for Primary,
Secondary and Tertiary Alkoxylates (0.4%)

| SIL- | | | | | | | |
|---|---|---|---|---|---|---|---|
| ID | R1, R3 | C Link to O | Initial | 1 h | 2 h | 4 h | 6 h |
| SIL-14 | 3-Pentyl | Secondary | 43 | 44 | 43 | 46 | 46 |
| SIL-15 | 2-Pentyl | Secondary | 40 | 41 | 43 | 41 | 44 |
| SIL-16 | 2-Butyl | Secondary | 8 | 8 | 8 | 8 | 6 |
| SIL-17 | 3-Methyl-2-Butyl | Secondary | 41 | 42 | 37 | 42 | 42 |
| SIL-18 | 4-Methyl-2-pentyl | Secondary | 46 | 46 | 44 | 43 | 48 |
| SIL-8 | 2-methyl-2-butyl | Tertiary | 46 | 43 | 45 | 42 | 49 |

### Effect of Concentration on Spreading

This example demonstrates that the degree of spreading may be controlled by either the concentration of the alkoxysilane surfactant, or by the structure of R¹ and R³ groups employed. At times a high level of spreading is desired (i.e. when the spray volume is between 10 and 300 L/ha), and yet at other times a low level of spreading is desired (i.e. when spray volumes are in excess of 500 L/ha, or even as high as 8000 L/ha), because a high level of spreading may promote the agrochemical spray to run-off the crop or weeds being treated, resulting in a poor performing application. Therefore, controlling the spreading gives the applicator more flexibility in how they treat specific crops.

Spreading was determined as described above. However, in this case the alkoxysilane surfactant solutions were prepared in deionized water that was further purified with a Milli-Q ultrapure filtration system, no buffer (˜pH 5). Table 10 demonstrates that in general, as concentration of the alkoxysilane surfactant increases, there is a corresponding increase in spreading, which is a desirable property.

TABLE 10
Impact of alkoxysilane surfactant concentration on spreading

| No. C's | | | Connection | Spread diameter (mm) | | | | | |
|---|---|---|---|---|---|---|---|---|---|
| R1, R3 | SIL-ID | R1 and R3 | Type | 0.05% | 0.10% | 0.20% | 0.40% | 0.60% | 1.0% |
| 4 | SIL-16 | 2-Butyl | Secondary | 5 | 5 | 7 | 8 | 9 | 28 |
| 5 | SIL-17 | 3-Methyl-2-Butyl | Secondary | 5 | 6 | 6 | 33 | 39 | 34 |
| 5 | SIL-14 | 3-Pentyl | Secondary | 6 | 7 | 18 | 45 | 39 | 30 |
| 5 | SIL-15 | 2-Pentyl | Secondary | 7 | 7 | 28 | 43 | 42 | 31 |
| 5 | SIL-8 | 2-methyl-2-butyl | Tertiary | 9 | 31 | 46 | 44 | 39 | 36 |
| 6 | SIL-18 | 4-Methyl-2-pentyl | Secondary | 9 | 25 | 41 | 45 | 41 | 37 |

### The Effect of Adjuvant on Herbicide Weed Control

Spray Protocol: A lab spray trial was conducted to evaluate the effect of the silane compositions in accordance with the present technology on the performance of various herbicides.

Target weeds were grown from seed, under controlled conditions in a “Caron Model 7301-50-2” Growth chamber using simulated full sunlight. Sprays were applied to the target weeds at the 4-6 leaf growth stage using a DeVries Generation 4—Research Track Sprayer with a T-Jet 8002E nozzle at an equivalent spray volume of 100 L/ha.

Effect of adjuvant on the performance of 2,4-D Amine on Redroot pigweed (Amaranthus retroflexus, EPPO Code: AMARE).

SIL-8 was compared to a conventional trisiloxane alkoxylate (TSA-1) as a spray adjuvant, to improve the performance of 2,4-D Amine (herbicide) on AMARE. The spray protocol is described above. The 2,4-D Amine was applied at a sub lethal dose (25% of label rate) to show the impact of the adjuvant on performance. Assessment of weed control was made by a visual observation as compared to an untreated check.

Table 11 shows that SIL-8 gave improved control of AMARE at 14 days after treatment (DAT), relative to the TSA-1 and the herbicide alone. Additionally, performance of SIL-8 increased with an increase in concentration from 0.1 to 0.15%. Although the effect was greater at 0.2% (70%) than at 0.1% (66%), there was a decrease from 79% to 70% for SIL-8 at going from 0.15% to 0.2%), which may be due to increased spreading and potential run-off.

TABLE 11

| Treat. | | Adjuvant | 2,4-D amine | | |
|---|---|---|---|---|---|
| No. | Adjuvant | (wt %) | (wt %) | 7-DAT | 14-DAT |
| 1 | TSA-1 | 0.10% | 0.25% | 46 | 55 |
| 2 | SIL-8 | 0.10% | 0.25% | 51 | 66 |
| 3 | SIL-8 | 0.15% | 0.25% | 45 | 79 |
| 4 | SIL-8 | 0.20% | 0.25% | 43 | 70 |
| 5 | None | None | 0.25% | 46 | 55 |
| 6 | None | None | None | 0 | 0 |

Control of Yellow Foxtail with Glyphosate-Isopropyl Amine Salt (0.75% a.i.)

Glyphosate-isopropylamine salt was applied at 0.75% a.i. to Yellow foxtail at a 15 cm growth-stage. The spray mixtures were applied either as herbicide alone, or in combination with the silane compositions SIL-6, SIL-9 and SIL-12 at an equivalent spray volume of 100 L/ha. A visual assessment of weed control was made at 7 and 14 Days After Treatment (DAT). The application method is the same as previously described.

This example demonstrates that the Silane Surfactants of the present invention can improve the response of glyphosate-isopropylamine salt on Yellow Foxtail (Setaria pumila), by providing a stronger herbicide response at 7 day after treatment, as compared to the herbicide alone (Table 12). Additionally, treatments 1-4, gave equivalent or better control of Yellow Foxtail at 14 DAT.

TABLE 12

| | | Adjuvant | | |
|---|---|---|---|---|
| Spray ID | Treatment | (Wt %) | 7 DAT | 14 DAT |
| 1 | SIL-12 | 0.40% | 52 | 95 |
| 2 | SIL-12 | 0.20% | 47 | 92 |
| 3 | SIL-12 | 0.10% | 47 | 98 |
| 4 | SIL-9 | 0.20% | 53 | 95 |
| 5 | SIL-6 | 0.10% | 47 | 80 |
| 6 | Glyphosate | 0 | 20 | 92 |

### The Effect of Adjuvant on Herbicide Response on Velvetleaf

GoalTender (Oxyflurofen; Nufarm) was applied to Velvetleaf (Abutilon theophrasti) at the 3-4 leaf stage using 0.188% herbicide (30% of the recommended label rate) to allow for adjuvant improvements to be observed. GoalTender was applied with and without adjuvant. SIL-8 was compared to a herbicide alone and applied at 100 L/ha equivalent spray volume. A visual assessment of weed control was made at 7, 14, and 21 DAT. The application method is described above.

Table 13 demonstrates that both concentrations of SIL-8 gave an improvement in herbicide response relative to the herbicide alone.

TABLE 13

| | Adjuvant | 7 DAT | 14 DAT | 21 DAT |
|---|---|---|---|---|
| ID | (wt %) | (Control %) | (Control %) | (Control %) |
| Goaltender | None | 24.3 | 30.8 | 25.5 |
| SIL-8 | 0.10% | 40.0 | 43.0 | 30.5 |
| SIL-8 | 0.20% | 44.3 | 45.0 | 34.5 |

### Biodegradability and Aquatic Toxicology

The biodegradability of the Silane Surfactants in accordance with aspects and embodiments of the present invention and several conventional trisiloxane alkoxylates (TSA) was evaluated according to the OECD methods described above. Table 14 demonstrates that SIL-5, SIL-8, and SIL-11 (representative of three different dialkoxy silane surfactants) provide a high level of biodegradability (all >90% in 28 days), which confirm a completely and readily biodegradation after 28 days according to OECD criteria. The traditional TSAs (TSA-1 and TSA-2), however, do not achieve sufficient biodegradability to be classified as “Readily Biodegradable”. Nevertheless, with 62% and 23.8% biodegradation in 28 days, TSA-1 and TSA-2 shows ultimate and inherent biodegradation, respectively.

Regarding aquatic toxicology profile for fish (GHS Category 3), SIL-5, SIL-8, and SIL-11 had a higher Acute LC50 than any of the TSA surfactants (OECD Test Guideline 203).

TABLE 14

| Test | SIL-5 | SIL-8 | SIL-11 | TSA-1 | TSA-2 |
|---|---|---|---|---|---|
| Biodegradability | 98.9% | 98.6% | 98.0% | 62% | 23.8 |
| (28 days) | | | | | |
| Readily | Yes | Yes | Yes | No | No |
| Biodegradable | | | | | |
| Aquatic Toxicity* | 21.2 | 21.4 | 11.9 | 4.9 | 2.4 |
| Fish (mg/L) | Acute | Acute | Acute | Chronic | Acute |
| Aquatic Toxicity | 3 | 3 | 3 | 2 | 2 |
| GHS Category | | | | | |

Control of Stink-Bug (Piezodorus guildinii) in Greenbeans

This example demonstrates the effect of adjuvant on the efficacy of Cefanol® acephate (750 g/kg) insecticide (Sipcam Nichino, Brazil S.A.), in red banded stink bug (Piezodorus guildinii) control on green beans (Phaseolus vulgaris).

A composition of the present invention (SIL-8) was compared to a conventional trisiloxane alkoxylate (TSA-2) for the improvement of the insecticide acephate in the control of stink-bug. The objective is to demonstrate, that SIL-8, has a similar level of efficacy to TSA-2.

The experiment was conducted with a randomized block design, with 6 treatments (including the untreated check) and 4 repetitions. Each plot was of 12 m² in area. The data obtained were subjected to analysis of variance and the average of the treatments compared using the Tukey test to 5% probability test.

During the trial there were 5 evaluation periods: 0, 3, 5 and 7 Days After Application (DAA), for determining the number of red banded stink bugs in each plot evaluated.

The treatments were applied using a CO₂ pressurized Backpack sprayer, with 4 nozzles spaced 50 cm between each one. Nozzles type XR11002 (Flat Fan) and a spray volume 150 L·ha. Table 15 provides a description of the treatments.

TABLE 15
Description of treatments, active ingredient, formulation
and dose of the respective Adjuvant used.

| No | Treatments | Active Ingredient | Formulation | Dosage |
|---|---|---|---|---|
| 1 | Control | — | — | — |
| 2 | Cefanol | Acephate | SP | 0.50 (kg · ha) |
| 3 | Cefanol | Acephate | SP | 0.50 (kg · ha) |
| | SIL-8 | | SL | 0.05 (%) |
| 4 | Cefanol | Acephate | SP | 0.50 (kg · ha) |
| | SIL-8 | | SL | 0.1 (%) |
| 5 | Cefanol | Acephate | SP | 0.50 (kg · ha) |
| | TSA-2 | Trisiloxane | NA | 0.05 (%) |
| 6 | Cefanol | Acephate | SP | 0.50 (kg · ha) |
| | TSA-2 | Trisiloxane | NA | 0.1 (%) |

At 0 DAA (initial), the pest was evenly distributed and there was no statistically significant difference between the treatments.

At 1, 3, 5 and 7 DAA all treatments with insecticide andinsecticide+adjuvant were more efficient than the control (Check) treatment.

In general, Table 16 shows the treatments with insecticide+adjuvants were more efficient at controlling the pest than the treatment with insecticide alone.

Additionally, the composition of the present invention (SIL-8) results were similar to the conventional silicone adjuvant, TSA-2. However, as shown above, SIL-8 is Readily Biodegradable (98.9% OECD 301B, 28d) and had a better Aquatic Tox profile (higher LC58 for fish: 28.4 mg/L) than TSA-2, which was not Readily Biodegradable (23.8%, 28d, OECD 301B) and had a lower LC50 for fish (2.4 mg/L).

TABLE 16
Number of red banded stink bug (Piezodorus guildinii) and percentage of
control at 0, 1, 3, 5 and 7DAA, on Green Beans (Phaseolus vulgaris).

| | | | Eff. | | Eff. | 3 | Eff. | | Eff. | | Eff. |
|---|---|---|---|---|---|---|---|---|---|---|---|
| No | TMT | 0 DAA | % | 1 DAA | % | DAA | % | 5 DAA | % | 7 DAA | % |
| 1 | Control | 1.8 a | 0.0 | 2.1 a | 0.0 | 1.7 a | 0.0 | 0.9 a | 0.0 | 0.9 a | 0.0 |
| 2 | Acephate | 1.8 a | 0.0 | 0.5 b | 76.0 | 0.7 b | 60.0 | 0.5 a | 45.5 | 0.3 b | 63.6 |
| 3 | Acephate | 1.8 a | 0.0 | 0.1 b | 96.0 | 0.3 | 85.0 | 0.1 a | 90.9 | 0.2 b | 81.8 |
| | SIL-8 | | | | | bc | | | | | |
| | (0.05%) | | | | | | | | | | |
| 4 | Acephate + | 1.5 a | 0.0 | 0.0 b | 100.0 | 0.3 | 80.0 | 0.4 a | 54.5 | 0.4 ab | 54.5 |
| | SIL-8 | | | | | bc | | | | | |
| | (0.1%) | | | | | | | | | | |
| 5 | Acephate + | 1.9 a | 0.0 | 0.0 b | 100.0 | 0.0 c | 100.0 | 0.1 a | 90.9 | 0.3 b | 72.7 |
| | TSA-2 | | | | | | | | | | |
| | (0.05%) | | | | | | | | | | |
| 6 | Acephate + | 1.8 a | 0.0 | 0.1 b | 96.0 | 0.1 | 95.0 | 0.2 a | 81.8 | 0.2 b | 81.8 |
| | TSA-2 | | | | | bc | | | | | |
| | (0.1%) | | | | | | | | | | |

### Use of Co-Surfactants

Although the present alkoxysilane materials may be used as the sole adjuvant in a spray mixture, other surfactants may also be employed. Such co-surfactants may contribute to the overall performance, such as improving the spreading or surface tension by balancing these properties to achieve the desired result. Also, co-surfactants may be useful as dispersants or emulsifiers.

This example demonstrates that mixtures of an alkoxysilane in accordance with aspects and embodiments of the present technology with other surfactants can maintain a high level of spreading. Therefore, spreading was observed for SIL-8 alone, verses mixtures with various cosurfactants. The spreading tests were conducted as outlined above.

Table 17 shows that blends of a number of cosurfactants with the silane alkoxylate SIL-8 maintained a high level of spreading (Compared to SIL-8 alone), as well as improved spreading over Triton X-100 (Octylphenol ethoxylate containing 10 ethyleneoxide units). At 0.2%, all of the SIL-8 blends provided a higher level of spreading than 0.2% X-100, while at 0.1% spreading for the blends was greater than or equivalent to the X-100, although at half the concentration.

TABLE 17
Effect of Cosurfactants on Spreading Properties
of Silane Alkoxylate Surfactant

| Sample | Blend Composition | 0.05 wt % | 0.10 wt % | 0.20 wt % |
|---|---|---|---|---|
| A | SIL-8 (100%) | 15 | 35 | 53 |
| B | SIL-8 (50%) + | 29 | 39 | 53 |
| | Lutensol XL-50 (50%) | | | |
| C | SIL-8 (40%) + | 33 | 44 | 40 |
| | Lutensol XL-50 (60%) | | | |
| D | SIL-8 (50%) + | nd | 36 | 46 |
| | Rhodasurf DA-530 (50%) | | | |
| E | SIL-8 (30%) + | nd | 40 | 46 |
| | Rhodasurf DA-530 (70%) | | | |
| F | Sil-8 (50%) + | nd | 18 | 39 |
| | Agnique PG 8105 (50%) | | | |
| G | SIL-8 (30%) + | nd | 9 | 27 |
| | Agnique PG 8105 (70%) | | | |
| H | Triton X-100 (100%) | nd | nd | 10 |

### Herbicide Trial on Velvetleaf

This example demonstrates the effectiveness of cosurfactant blends containing an alkoxysilane surfactant in accordance with aspects and embodiments of the present technology as spray adjuvants to improve the performance of a herbicide for weed control relative to a conventional trisiloxane alkoxylate adjuvant (TSA-2). Therefore, a lab spray trial was conducted to determine the effect of adjuvant on the control of velvetleaf (Abutilon theophrasti) with Glyphosate-isopropyl amine salt. Blends of SIL-8 with Lutensol XL-50 were prepared by combining the two surfactants in a beaker and mixing until a homogeneous solution was achieved. Table 18 defines the compositions of the blends.

TABLE 18
Composition of Alkoxysilane Surfactant/Nonionic
Surfactant Blends

| Component | Blend 1 (Wt %) | Blend 2 (Wt %) |
|---|---|---|
| SIL-8 | 50% | 40% |
| XL-50 | 50% | 60% |

Plants were treated at the 4-5 true leaf growth-stage. Treatments were applied using 0.70% Roundup Custom (0.377% active ingredient), and the spray mixtures were applied either as herbicide alone, or in combination with an adjuvant at 0.1% and 0.2%. Treatments were applied to velvetleaf at an equivalent spray volume of 113 L/ha. A visual assessment of weed control (0 to 100%) was made at 3, 7, 10 and 14 Days After Treatment (DAT).

Table 19 demonstrates that blend compositions of the present invention, containing SIL-8, provided a stronger glyphosate response at 10 and 14 days after application than the herbicide alone or TSA-2.

TABLE 19
Effect of Adjuvant on Velvetleaf Control
with Glyphosate-isopropylamine Salt

| ID | Treatment | 3 DAT | 7 DAT | 10 DAT | 14 DAT |
|---|---|---|---|---|---|
| 1 | Untreated Check | 0.0% | 0.0% | 0.0% | 0.0% |
| 2 | RoundUp Custom | 7.5% | 27.5% | 60.0% | 80.0% |
| | (0.70 wt %) | | | | |
| 3 | +TSA-2 (0.1 wt % ) | 10.0% | 40.0% | 70.0% | 85.0% |
| 4 | +TSA-2 (0.2 wt % ) | 7.5% | 35.0% | 65.0% | 81.8% |
| 5 | +Blend-1 (0.1%) | 15.0% | 45.0% | 80.0% | 94.8% |
| 6 | +Blend-1 (0.2%) | 10.0% | 37.5% | 75.0% | 87.5% |
| 7 | +Blend-2 (0.1%) | 6.3% | 37.5% | 75.0% | 87.5% |
| 8 | +Blend-2 (0.1%) | 15.0% | 43.8% | 80.0% | 95.0% |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of silane compositions, methods of making the same, agrochemical compositions comprising the same, and methods of treating agricultural areas and materials. Modifications may occur to those skilled in the art and to those who may make and use the invention. The disclosed embodiments are merely for illustrative purposes and not intended to limit the scope of the invention or the subject matter set forth in the claims.

What is claimed is:

1. A silane composition comprising a silane of the formula:
R¹OSi(R²)(Z)OR³ (I)
wherein:
R¹ and R³ are each independently selected from a hydrocarbon having 4 to 8 carbons, where a carbon atom connected to the oxygen is a secondary or tertiary carbon;
R² is selected from a monovalent hydrocarbon group of 1 to 3 carbons;
Z is a hydrophilic group of the general structure:
—R⁴O[CH₂CH₂O]ₘ[CH₂CH(R⁵)O]ₙR⁶
where R⁴ is a divalent hydrocarbon group of 2 to 6 carbons;
R⁵ is methyl or ethyl,
R⁶ is selected from H, a monovalent hydrocarbon group of 1 to 4 carbons, or —C(O)R⁷, where R⁷ is a monovalent hydrocarbon of 1 to 4 carbon atoms; and
m is 3 to 15;
n is 0 to 8; and
m+n is 6 to 18.

2. The silane composition of claim 1, wherein the hydrocarbon having 4 to 8 carbons for R¹ and R³ are each independently selected from a branched hydrocarbon having 4 to 8 carbons.

3. The silane composition of claim 1, wherein the hydrocarbon having 4 to 8 carbons for R¹ and R³ are each independently selected from a branched hydrocarbon having 4 to 6 carbons.

4. The silane composition of claim 1, wherein R¹ and R³ are each independently selected from butyl, isobutyl, tert-butyl, 2-methyl butyl, 2-ethyl butyl, 2,2-dimethyl butyl, 3,3-dimethyl butyl, 1,2-dimethylbutyl, 1,3-dimethylbutyl, 1,2,2-trimethylpropyl, 1,1,2-trimethylpropyl, pentyl, isopentyl, 1-methyl pentyl, 2-methyl pentyl, 3-methyl pentyl, 4-methyl pentyl, 2-ethyl pentyl, 3-ethyl pentyl, 1,2-dimethyl propyl, 1,1-dimethyl propyl, 3-propyl pentyl, 3,3-dimethyl propyl, hexyl, heptyl, and octyl.

5. The silane composition of claim 1, wherein n is 0.

6. The silane composition of claim 1, wherein m is from about 4 to about 8, and n is from 0 to about 5.

7. The silane composition of claim 1, wherein
R¹ and R³ are each independently selected from a branched hydrocarbon group of 4 to 8 carbons;
R² is selected from a monovalent hydrocarbon group of 1 to 3 carbons;
R⁴ is selected from a divalent hydrocarbon group of 2 to 6 carbons,
R⁵ is selected from methyl or ethyl;
R⁶ is selected from H, a monovalent hydrocarbon group of 1 to 4 carbons, or acetyl;
m is from about 3 to about 15;
n is 0 to about 8.

8. The silane composition of claim 7, wherein R⁴ is selected from a branched hydrocarbon of 3 to 4 carbons.

9. The silane composition of claim 7, wherein m is from about 4 to about 8.

10. The silane composition of claim 7, wherein n is 0 to about 3.

11. The silane composition of claim 1, wherein
R¹ and R³ are independently selected from a branched hydrocarbon group of 4 to 8 carbons;
R² is selected from a monovalent hydrocarbon group of 1 to 2 carbons;
R⁴ is selected from a divalent hydrocarbon group of 3 to 4 carbons;
R⁵ is methyl;
R⁶ is H;
m is 6 to 12; and
n is 0.

12. The silane composition of claim 1, wherein
R¹ and R³ are independently selected from a branched hydrocarbon of 5 to 6 carbons;
R² is methyl;
R⁴ is selected from a divalent hydrocarbon group of 3 to 4 carbons;
R⁵ is methyl;
R⁶ is H;
m is about 4 to 8; and
n is 1 to 3.

13. The silane composition of claim 1, wherein:
R¹ and R³ are independently selected from a branched hydrocarbon having 5 carbons;
R² is selected from methyl or ethyl;
R⁴ is selected from a divalent hydrocarbon having 3 to 4 carbons;
R⁵ is methyl;
R⁶ is selected from butyl or acetyl;
m is about 6 to 15; and
n is 0 to 2.

14. The silane composition of claim 1, wherein:
R¹ and R³ are independently selected from a branched hydrocarbon group of 4 to 6 carbons;
R² is methyl;
R⁴ is selected from a divalent hydrocarbon group of 3 to 4 carbons;
R⁵ is methyl;
R⁶ is H;
m is about 10 to 15; and
n is 0 to 3.

15. The silane composition of claim 1, wherein the composition has a GHS Class 2 acute aquatic toxicity and/or a GHS Class 3 acute toxicity for fish according to OECD Test Guideline 203.

16. The silane composition of claim 1, wherein the composition has an Acute Oral LD50 of ≥2000 mg/Kg (Rat).

17. The silane composition of claim 1, wherein the composition has ≥60% biodegradability in 28 days according to the OECD 301B method and/or the OECD 301F method.

18. The silane composition of claim 17, wherein the composition is classified as inherently or ultimately or readily biodegradable according to the OECD 301B method and/or the OECD 301F method.

19. The silane composition of claim 1, wherein the composition has a “Not Classified” status for toxicity.

20. An agrochemical composition comprising:
(A) a silane composition comprising a silane of the formula:
R¹OSi(R²)(Z)OR³ (I)
wherein:
R¹ and R³ are each independently selected from a hydrocarbon having 4 to 8 carbons, where a carbon atom connected to the oxygen is a secondary or tertiary carbon;
R² is selected from a monovalent hydrocarbon group of 1 to 3 carbons;
Z is a hydrophilic group of the general structure:
—R⁴O[CH₂CH₂O]ₘ[CH₂CH(R⁵)O]ₙR⁶
where R⁴ is a divalent hydrocarbon group of 2 to 6 carbons;
R⁵ is methyl or ethyl,
R⁶ is selected from H, a monovalent hydrocarbon group of 1 to 4 carbons, or —C(O)R⁷, where R⁷ is a monovalent hydrocarbon of 1 to 4 carbon atoms; and
m is 3 to 15;
n is 0 to 8; and
m+n is 6 to 18; and
(B) a material selected from herbicide, an insecticide, a growth regulator, a fungicide, a miticide, an acaricide, a fertilizer, a biological, a plant nutritional, a micronutrient, a biocide, a paraffinic mineral oil, a methylated seed oil, a vegetable oil, a water conditioning agent, a modified clay, a foam control agent, a co-surfactant, a wetting agent, a dispersant, an emulsifier, a deposition aid, an antidrift component, water, or a combination of two or more thereof.

21. The agrochemical composition of claim 20, wherein in the silane composition (A), the hydrocarbon having 4 to 8 carbons for R¹ and R³ are each independently selected from a branched hydrocarbon having 4 to 8 carbons.

22. The agrochemical composition of claim 20, wherein in the silane composition (A), R¹ and R³ are each independently selected from butyl, isobutyl, tert-butyl, 2-methyl butyl, 2-ethyl butyl, 2,2-dimethyl butyl, 3,3-dimethyl butyl, 1,2-dimethylbutyl, 1,3-dimethylbutyl, 1,2,2-trimethylpropyl, 1,1,2-trimethylpropyl, pentyl, isopentyl, 1-methyl pentyl, 2-methyl pentyl, 3-methyl pentyl, 4-methyl pentyl, 2-ethyl pentyl, 3-ethyl pentyl, 1,2-dimethyl propyl, 1,1-dimethyl propyl, 3-propyl pentyl, 3,3-dimethyl propyl, hexyl, heptyl, and octyl.

23. The agrochemical composition of claim 20, wherein in the silane composition (A), n is 0.

24. The agrochemical composition of claim 20, wherein in the silane composition (A), m is from about 4 to about 8, and n is from 0 to about 5.

25. The agrochemical composition claim 20, wherein in the silane composition (A),
R¹ and R³ are each independently selected from a branched hydrocarbon group of 4 to 8 carbons;
R² is selected from a monovalent hydrocarbon group of 1 to 3 carbons;
R⁴ is selected from a divalent hydrocarbon group of 2 to 6 carbons,
R⁵ is selected from methyl or ethyl;
R⁶ is selected from H, a monovalent hydrocarbon group of 1 to 4 carbons, or acetyl;
m is from about 3 to about 15;
n is 0 to about 8.

26. The agrochemical composition of claim 20, wherein in the silane composition (A),
R¹ and R³ are independently selected from a branched hydrocarbon group of 4 to 8 carbons;
R² is selected from a monovalent hydrocarbon group of 1 to 2 carbons;
R⁴ is selected from a divalent hydrocarbon group of 3 to 4 carbons;
R⁵ is methyl;
R⁶ is H;
m is 6 to 12; and
n is 0.

27. The agrochemical composition of claim 20, wherein in the silane composition (A) has one or more of: a GHS Class 2 acute aquatic toxicity and/or a GHS Class 3 acute toxicity for fish according to OECD Test Guideline 203; an Acute Oral LD50 of ≥2000 mg/Kg (Rat); ≥60% biodegradability in 28 days according to the OECD 301B method and/or the OECD 301F method; and/or is classified as inherently or ultimately or readily biodegradable according to the OECD 301B method and/or the OECD 301F method.

28. The agrochemical composition of claim 20, wherein the composition comprises a co-surfactant.

29. The agrochemical composition of claim 28, comprising from about 25% to about 80% of a silane of formula (I) and from about 20% to about 75% of co-surfactant.

30. A method of treating an agricultural area comprising applying the agrochemical composition of claim 1 and an agrochemical material to an area within the agricultural area.

31. The method of claim 30, wherein the silane composition and the agrochemical material are provided as a mixture.

32. The method of claim 31, wherein the silane composition and the agrochemical material are separately provided, and the silane composition is added to the agrochemical material at the point of application.

33. The method of claim 30, wherein the silane composition is provided in an amount of from about 0.01 wt. % to about 5 wt. % at the point of use.
